(19) United States
(12) Patent Application Publication
(10) Pub. No.: US 2005/0272500 A1
(43) Pub. Date: Dec. 8, 2005

(54) Gaming machine

(75) Inventors: Tatsuhiko Tanimura, Tokyo (JP); Hirofumi Sekiguchi, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/142,188

(22) Filed: Jun. 2, 2005

(30) Foreign Application Priority Data
Jun. 4, 2004 (JP) 2004-167698

(51) Int. Cl. A63F 13/00

(52) U.S. Cl. 463/20

(57) ABSTRACT

It is disclosed the slot machine 1 provided with a variable display device having a rotation member on an outer periphery of which a plurality of symbols are formed and LED lamps for illuminating the rotation member from an inner side of the rotation member, a liquid crystal display device having a cold cathode ray tubes for illuminating the rotation member from an outer side of the rotation member and a light transmittable area through which light passes from a rear side of the light transmittable area, a determination device for determining whether display by the variable display device is conducted on the light transmittable area prior to display by the image display device or the display by the image display device is conducted on the light transmittable area prior to the display by the variable display device, and a light amount adjustment device for adjusting light amount emitted from the LED lams and the cold cathode ray tubes based on a determination result determined by the determination device.

### CROSS-REFERENCE TO THE RELATED APPLICATION (S)

This application is based upon and claims a priority from the prior Japanese Patent Application No. 2004-167698 filed on Jun. 4, 2004, the entire contents of which are incorporated herein by reference.

### BACKGROUND OF THE INVENTION

1. Field of the Invention

The present invention relates to a gaming machine with an image display device arranged in front of a variable display device on which symbols are variably displayed.

2. Description of Related Art

Conventionally, it is known a gaming machine in which a display device (front display device) is independently provided at a front side of a variable display device on which symbols are variably displayed. For example, as shown in Unexamined Japanese Publication No. 2001-252394, it is disclosed a gaming machine in which it is provided a rotation reel display device for conducting variable display of symbols and a light transmittable liquid crystal display device or an transparent EL panel as the front display device. In this gaming machine, an illumination device for illumination of the rotation reel display device is arranged in front of the rotation reel display device and light emitted from the illumination device is irradiated to the rotation reel display device, thereby the outer peripheral surface of the rotation reel is brightened. As a result, the player can clearly see and recognize the rotation reel display device form the front side of the front display device.

And as shown in Unexamined Japanese Publication No. 6-269535, in order to brighten the reel and to be able to easily see the reel, it is also disclosed a gaming machine in which a back light (inner illumination device) constructed from LEDs (Light Emitting Diode) and the like is arranged within reels and light irradiates reels from the inner side thereof by utilizing the back light.

In the gaming machine in which the front display device is arranged in front of the rotation reel display device, in order that the reel can be easily seen form the front side of the front display device, it is desirable to brighten the outer peripheral surface of the reel by utilizing both the illumination device and the back light in the gaming machine.

However, if light of the illumination device is irradiated on the outer peripheral surface of the reel from an external, not only the symbol (object symbol) to be made conspicuous by light emitted from the back light but also the other symbols adjacent thereto are uniformly brightened. Therefore, even if the back light is illuminated from the inner side of the reel under such condition, the object symbol is made inconspicuous. Thus, there is a problem that enough effect of illumination by the back light cannot be obtained.

As mentioned, in the conventional gaming machine, even if both the illumination device and the back light are utilized, there is fear that illumination effect by two devices cannot be efficiently used.

Recently, in this kind of the gaming machine, from a point of view that it is required to raise variety and free degree of effect contents, there are many cases that effect is done on the front display device, therefore role of the front display device becomes important more and more. In this kind of the gaming machine, although game effect can be done by utilizing superimposition display conducted by both the rotation reel display device and the front display device, it is desirable that the game can be done while illumination by the illumination device and the back light are efficiently used, in order to make the effect contents effective.

### SUMMARY OF THE INVENTION

In order to dissolve the above problems, the present invention has been done and has an object to provide a gaming machine having a variable display device for conducting variable display of symbols and an image display device arranged in front of the variable display device, in which the game can be done while efficiently using illumination by the illumination device and the back light.

In order to accomplish the above object, according to one aspect of the present invention, it is provided a gaming machine comprising:
a variable display device having a rotation member on an outer periphery of which a plurality of symbols are formed and an inner illumination device for illuminating the rotation member from an inner side of the rotation member;
an image display device having an outer illumination device for illuminating the rotation member from an outer side of the rotation member and a light transmittable area through which light passes from a rear side of the light transmittable area;
a determination device for determining whether
(a) display by the variable display device is conducted on the light transmittable area prior to display by the image display device or
(b) the display by the image display device is conducted on the light transmittable area prior to the display by the variable display device; and
a light amount adjustment device for adjusting light amount emitted from the inner illumination device and the outer illumination device based on a determination result determined by the determination device.

In the above gaming machine, the light amount adjustment device adjusts the light amount emitted from the inner illumination device and the outer illumination device based on a determination result determined by the determination device. Thereby, light amount emitted from the inner illumination device and the outer illumination device can be changed, thus lightness and heaviness is given to the light amount of the inner illumination device and the outer illumination device.

As mentioned, according to the resent invention, in the gaming machine with the image display device arranged in front of the variable display device conducting variable display of the symbols, the game can be done while illumination by the inner illumination device and the outer illumination device is efficiently utilized.

As mentioned, according to the present invention, it can be provided a gaming machine with the variable display device for conducting the variable display of the symbols and image display device arranged in front of the variable display device, in which the symbol on the variable display device and the image displayed on the image display device can be easily seen.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view showing whole construction of a slot machine as a gaming machine according to the embodiment of the present invention,

FIG. 2 is a front view showing a lower image display portion of the slot machine shown in FIG. 1,

FIG. 3 is a perspective view showing construction of reels,

FIG. 4 is a perspective view showing one reel shown in FIG. 3

FIG. 5 is an explanatory view showing an outline construction of a liquid crystal display device when seeing from a rear side of a cabinet,

FIG. 6 is an exploded perspective view showing a part of the liquid crystal display device,

FIG. 7 is a block diagram showing an electrical construction of the slot machine,

FIG. 8 is a block diagram of an image control circuit,

FIG. 9 is a flowchart showing procedures in a main process from a start of a game to a termination of the game,

FIG. 10 is a side view of the reel, and

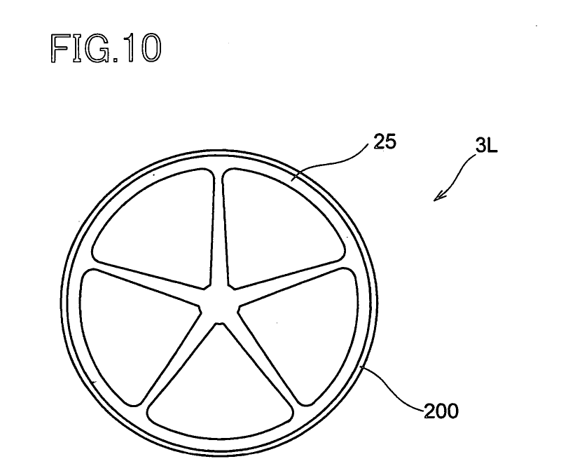

FIG. 11 is an explanatory view showing an outline construction of another liquid crystal display device when seeing from a rear side of a cabinet.

### DETAILED DESCRIPTION OF THE PREFERRED EMBODIMENTS

Hereinafter, the embodiment of the present invention will described. Here, the same number is utilized for the same element and repetitious explanation will be omitted.

In the embodiment, explanation will be done concerning with a slot machine 1 as an example in a case that the present invention is adopted for a gaming machine having a variable display device on which symbols are variably displayed.

(Whole Construction of the Slot Machine)

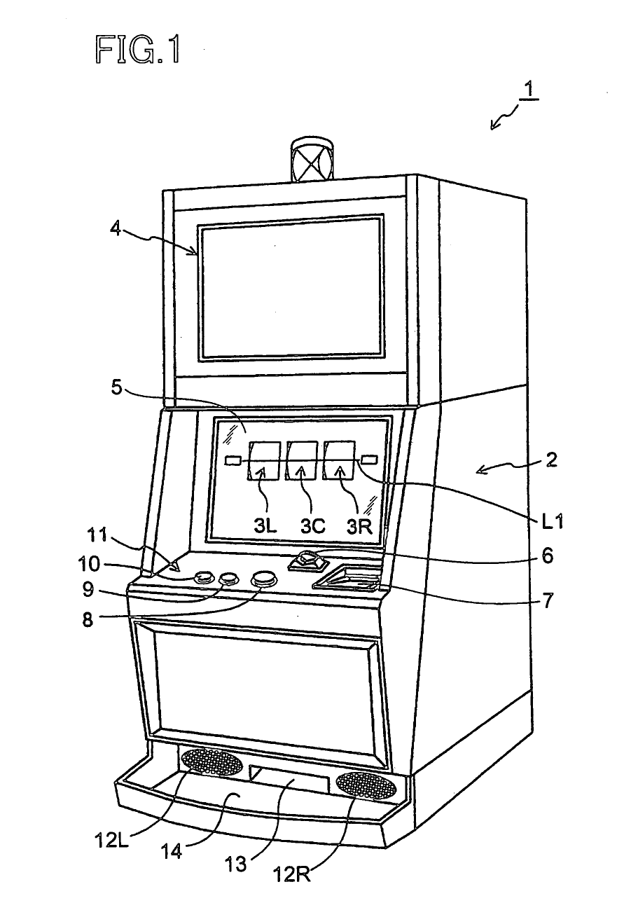

FIG. 1 is a perspective view showing whole construction of the slot machine 1. The slot machine 1 corresponding to the embodiment of the present invention has a variable display device for variably displaying symbols thereon and an image display device arranged in front of the variable display device. In the slot machine 1, it can be done a slot game by utilizing a plurality of symbols displayed on the variable display device.

The slot machine 1 has, according to an order from an upper position, an upper image display portion 4 arranged on a front plane of a cabinet 2 and a lower image display portion 5. The lower image display portion 5 is arranged in a center position of the cabinet 2 in a direction of the upper and lower positions and three mechanical reels 3L, 3C, 3R are rotatably arranged in the cabinet 2 along the horizontal line, so as to correspond to the lower image display portion 5.

Each of the reels 3L, 3C, 3R can be seen and recognized through each of image display areas 21L, 21C, 21R (mentioned later) of the lower image display portion 5 from an external. And as described in detail hereinafter, a symbol column (not shown) having a plural kinds of symbols is described on an outer periphery of each of the reels 3L, 3C, 3R, and the reels 3L, 3C, 3R construct the rotatable variable display device so that each of the symbols is variably displayed. Each of the reels 3L, 3C, 3R rotates at a constant speed (for example, 80 rotations/minute).

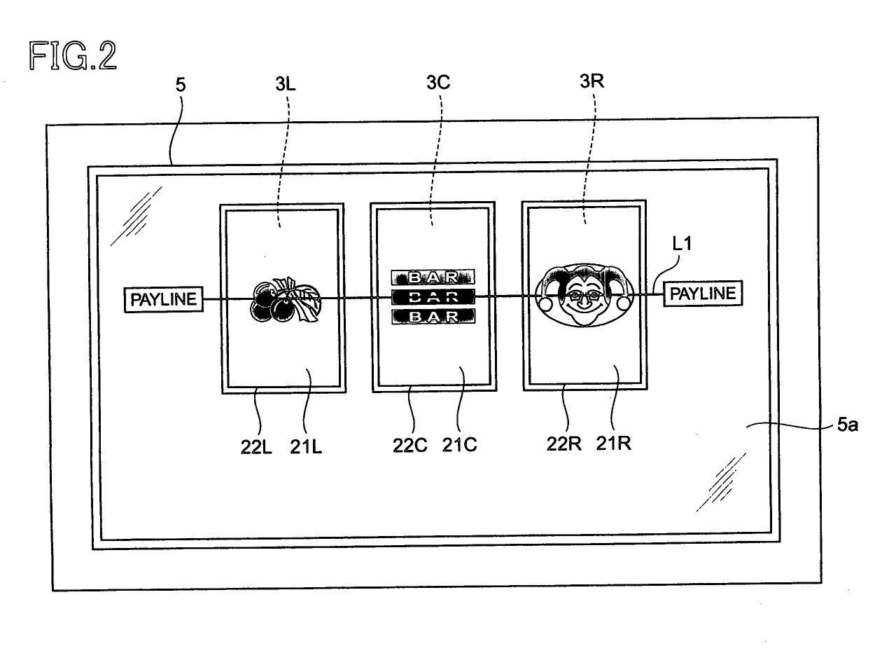

Corresponding to the reels 3L, 3C, 3R, it is formed one pay line L1 horizontally extending in the symbol display areas 21L, 21C, 21R, as shown in FIG. 2. Here, although not shown, in addition to the pay line L1, another pay lines may be independently formed at the upper and the lower positions and further two oblique pay lines may be formed. In a case that a plurality of the pay lines are formed, it is desirable that a number of the pay lines is changed according to a number of coins inserted. In this case, each pay line is activated corresponding to operation of BET switches 9, 10. The activated pay line is called as “active pay line” or “pay line”. Here, in FIG. 2, although it is indicated a state that symbols are stopped only on the pay line L1 in order to easily see, three symbols are generally displayed along the vertical line in each of the symbol display areas 21L, 21C, 21R.

And in the slot machine 1, a control table 11 horizontally extended is formed at a lower side of the lower image display portion 5. And on the control table 11, a coin insertion slot 6, a bill insertion slot 7, a spin switch 8, a 1-BET switch 9 and a maximum BET switch 10 are provided.

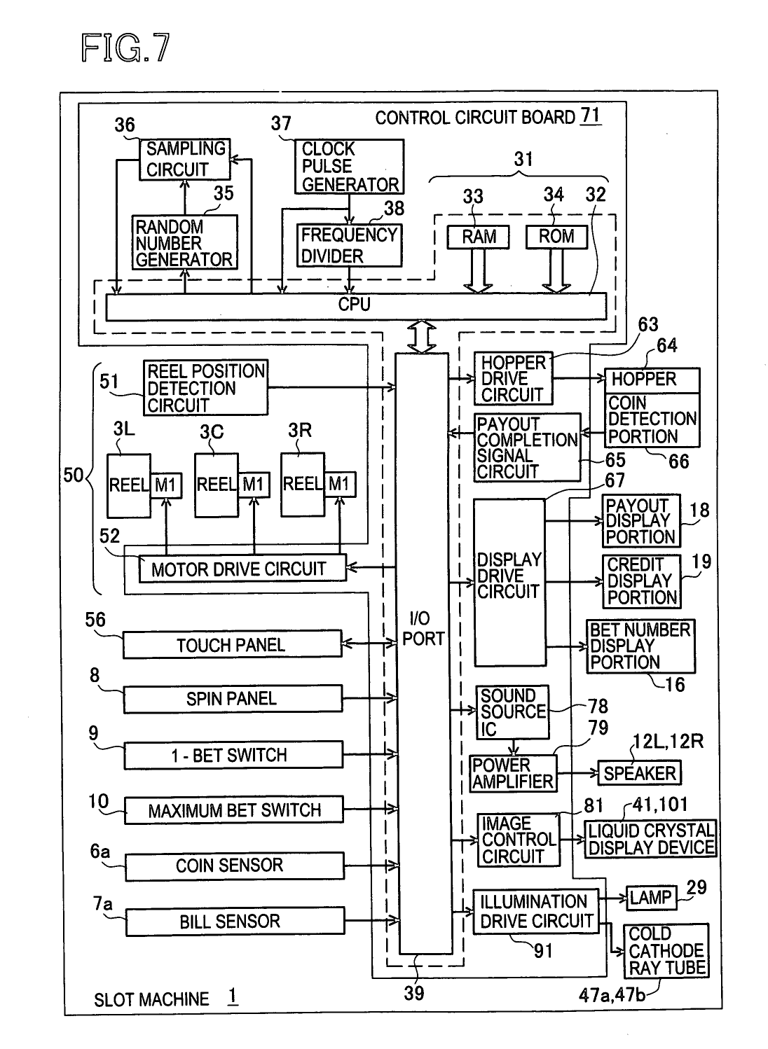

The coin insertion slot 6 is formed in order to insert a coin which the player bets for a game and has a coin sensor 6a (see FIG. 7) for outputting a signal indicating that the coin is inserted. And the bill insertion slot 7 is formed in order that the player inserts a bill thereinto and has a bill sensor 7a (see FIG. 7) for outputting a signal indicating that the player inserts the bill thereinto. And the spin switch 8 is formed in order to start variable display of the symbols within the symbol display areas 21L, 21C, 21R by rotation of the reels 3L, 3C, 3R, that is, in order that the player conducts operation to start the game. The 1-BET switch 9 is formed in order to bet one coin through one time operation thereof. The maximum BET switch 10 is formed in order to bet coins with the maximum number which can be betted in one game through one time operation thereof.

Further, in the slot machine 1, a coin payout opening 13 and a coin tray 14 for receiving the coins paid out from the coin payout opening 13 are formed at a bottom portion of the cabinet 2. Further, speakers 12L and 12R are arranged at both the left and the right positions while remaining the coin payout opening 13 therebetween.

(Explanation Concerning with Each of the Image Display Portions)

As shown in FIG. 2, the lower image display portion 5 has the image display areas 21L, 21C, 21R, window frame display portions 22L, 22C, 22R and an effect display area 5a. Display contents of the lower image display portion 5 is changed corresponding to the variable display mode and the stop display mode of the reels 3L, 3C, 3R and operation contents of a liquid crystal display device 41 mentioned later. Here, although a BET number display portion 16, a payout display portion 18 and a credit display portion 19 are displayed on the lower image display portion 5 in addition to the above areas, such portions are omitted in FIG. 2.

A liquid crystal display device 101 is arranged on the upper image display portion 4 and display contents thereof are changed corresponding to operation contents thereof.

The symbol display areas 21L, 21C, 21R are formed corresponding to the reels 3L, 3C, 3R, respectively and are areas to display the symbols described on each of the reels 3L, 3C, 3R so that the symbols can be seen and recognized. The symbol display areas 21L, 21C, 21R are made light transmittable so that the symbols described on each of the reels 3L, 3C, 3R can be seen and recognized therethrough.

The window frame display areas 22L, 22C, 22R are formed so as to enclose the symbol display areas 21L, 21C, 21R, respectively, and function as display windows of the symbols described on each of the reels 3L, 3C, 3R.

And in the effect display area 5a, there are displayed effect to increase interest for games and information necessary for the player to beneficially progress the game.

The display contents of the upper image display portion 4 are changed corresponding to operation contents of the liquid crystal display device 101.

(Construction of the Reel and LED Lamp)

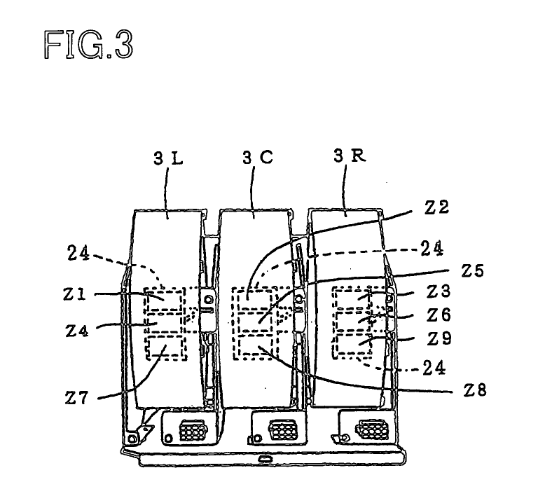

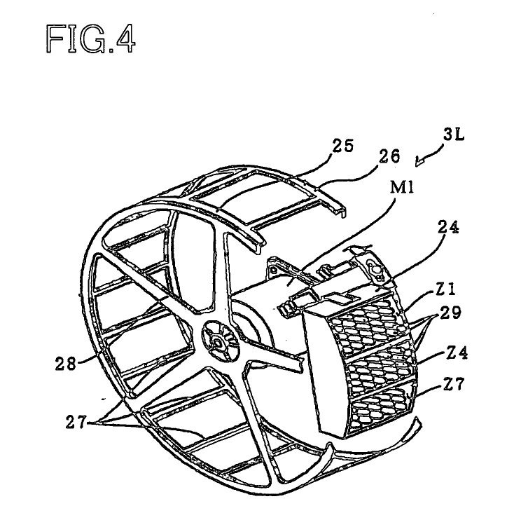

As shown in FIG. 3, each of the reels 3L, 3C, 3R is arranged along the horizontal line and is rotatable. And each of the reels 3L, 3C, 3R has the same construction. As shown in FIG. 4, the reel 3L has two circular frames 25, 26 with the same shapes, the circular frames 25, 26 being arranged while retaining a predetermined distance therebetween. The circular frames 25, 26 are connected by a plurality of connection members 27, thereby the reel 3L concludes to have a cylindrical frame construction. And the reel 3L has force transmission members 28 to transmit driving force of a stepping motor M1 arranged at a center position of the cylindrical frame construction to the circular frames 25, 26. And a light transmittable reel sheet (not shown) is provided on the outer periphery plane of the cylindrical frame construction so as to cover the connection members 27. A plurality of symbols are described on the reel sheet.

And in each of the reels 3L, 3C, 3R, a circuit board 24 for receiving LEDs is arranged at the rear side of the symbols appearing on each of the symbol display areas 21L, 21C, 21R. That is to say, three circuit boards 24 are arranged at the rear side of three symbol columns (symbol number is totally nine) appearing on the symbol display areas 21L, 21C, 21R. This circuit board 24 has three LED receiving portions aligned in the rotation direction of each of the reels 3L, 3C, 3R, and as shown in FIG. 4, a plurality of LED lamps 29 are arranged in each of the LED receiving portions in length and breadth directions. In FIG. 3, the LED receiving portions in each of the reels 3L, 3C, 3R are shown along three horizontal lines. And the LED receiving portions in the upper row are indicated as Z1, Z2, Z3, the LED receiving portions in the center row are indicated as Z4, Z5, Z6, and the LED receiving portions in the lower row are indicated as Z7, Z8, Z9. Further, each of the LED lamps 29 constructs an inner illumination device in the present invention and irradiates white light from the rear side of the reel sheet disposed along the outer periphery plane of each of the reels 3L, 3C, 3R. The LED lamps 29 construct a back light in the present invention. White light emitted from each of the LED lamps 29 goes through the reel sheet and reaches to the front side thereof and irradiates the liquid crystal display device 41.

And as shown in FIG. 12, a sheet member 200 with a plurality of protrusions like convex lenses on the reel sheet (not shown) is adhered on the reel 3L.

(Explanation of Image Display Device)

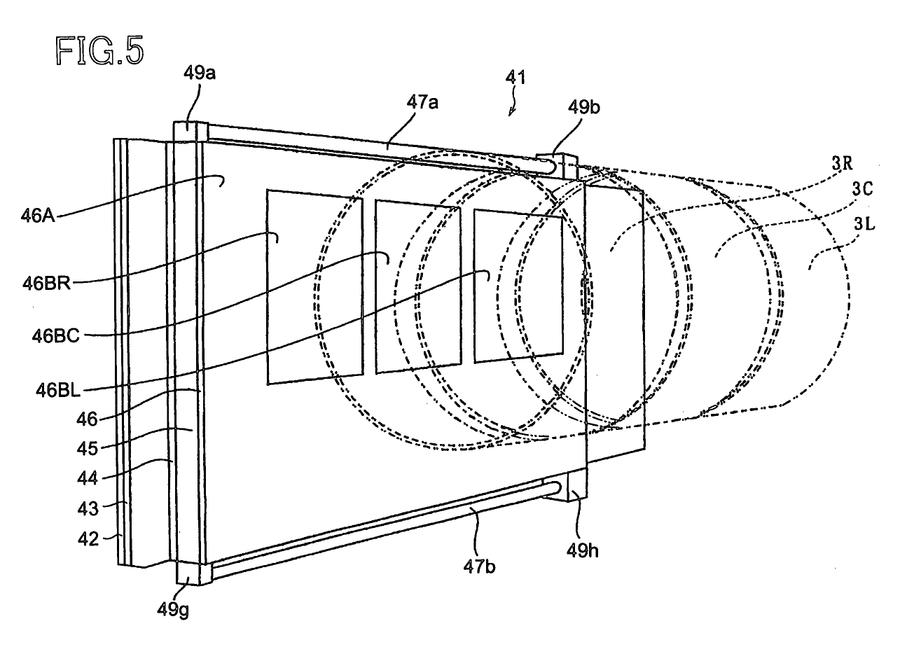

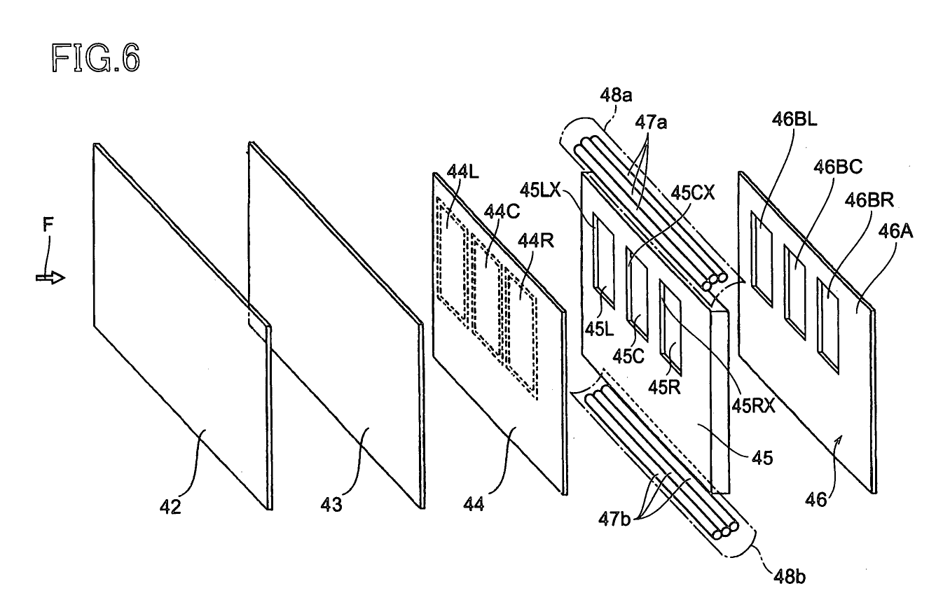

Next, the liquid crystal display device 41 constructing the lower image display portion 5 will be described with reference to FIGS. 5 and 6. FIG. 5 is a perspective view showing the outline construction of the liquid crystal display device 41 when seeing from the rear side of the cabinet 2. And FIG. 6 is an exploded perspective view showing a part of the liquid crystal display device 41.

The liquid crystal display device 41 is arranged at the front side of each of the reels 3L, 3C, 3R while retaining a predetermined distance therebetween so as to cover the reels 3L, 3C, 3R.

The liquid crystal display device 41 has a protect glass 42, a display plate 43, a liquid crystal panel 44 and a light guiding plate 45. Further the liquid crystal display device 41 has a reflection film 46, cold cathode ray tubes 47a, 47b as the white light source, lamp holders 49a, 49b, 49g, 49h and a flexible circuit board (not shown) comprising a table carrier package (TCP) on which a drive IC for driving the liquid crystal panel 44 is installed.

The protect glass 42 and the display plate 43 are made light transmittable. The protect glass 42 is mainly disposed to protect the liquid crystal panel 44. And on the display plate 43 a predetermined image (not shown) is described.

The liquid crystal panel 44 is formed by injecting liquid crystal between one transparent board such as a glass plate and the like on which thin layer transistors are formed and another transparent board opposite thereto. And the liquid crystal panel 44 has light transmittable areas 44L, 44C, 44R, which are able to pass light from the rear side thereof, corresponding to the symbol display areas 21L, 21C, 21R, respectively. This liquid crystal panel 44 becomes white display state (light can pass toward display plane side and such light can be seen from an external) under a condition that voltage is not applied to the liquid crystal panel 44 (liquid crystal panel 44 is not driven), thereby the liquid crystal panel 44 becomes normally white state that the reels 3L, 3C, 3R can be seen and recognized from the front side. By arranging the liquid crystal panel 44 becoming normally white state, even if the liquid crystal injected therein cannot be driven, the symbols described on each of the reels 3L, 3C, 3R can be seen and recognized through the symbol display areas 21L, 21C, 21R and the game can be done while seeing and recognizing variable display and stop display of each of the reels 3L, 3C, 3R.

The light guiding plate 45 has transparency and is arranged at the rear side of the liquid crystal panel 44. The light guiding plate 45 is provided to guide light from the cold cathode ray tubes 47a, 47b to the liquid crystal panel 44.

The light guiding plate 45 is formed of light transmittable material capable of guiding light such as acrylic resin and the like with about 2 cm thickness, and as shown in FIG. 6, the light guiding plate 45 has openings 45L, 45C, 45R for passing light therethrough, each of the openings 45L, 45C, 45R being corresponded to the light transmittable areas 44L, 44C, 44R, respectively. And light polarization pattern (not shown) is formed on the rear side of the light guiding plate 45 and light scattering process (for example; blast process or process for forming fine rough plane by utilizing sandpaper) is done on the inner end plane 45LX, 45CX, 45RX of the openings 45L, 45C, 45R. By performing the light scattering process, when light is irradiated on the inner end planes 45LX, 45CX, 45RX, such light is scattered, thereby the player can see and recognize the inner end planes 45LX, 45CX, 45RX as if they are emitting light. And such light is irradiated on the reels 3L, 3C, 3R and can be used as illumination thereof.

The reflection film 46 is provided to reflect light introduced into the light guiding plate 45 toward the surface of the light guiding plate 45. The reflection film 46 is formed from a white polyester film or aluminum thin film on which silver layer is vaporized. This reflection film 46 has a reflection area 46A and non-reflection areas 46BL, 46BC, 46BR. The non-reflection areas 46BL, 46BC, 46BR are made of transparent material and formed as light transmittable areas for transmitting incident light from the front surface without reflection. And the non-reflection areas 46BL, 46BC, 46BR are formed corresponding to the light transmittable areas 44L, 44C, 44R and are respectively arranged in front of the three symbols aligned along the vertical line, three symbols appearing when rotation of each of the reels 3L, 3C, 3R is stopped. The reflection area 46A reflects incident light from the front surface and functions as the illumination device for illuminating the areas mainly corresponding to the window frame display areas 22L, 22C, 22R and the effect display area 5a within the area of the liquid crystal display panel 44.

Three cold cathode ray tubes 47a, 47b are respectively arranged (six cathode ray tubes in total) along the upper and the lower ends of the light guiding plate 45 and the both ends of each of the cold cathode ray tubes 47a, 47b are supported through the lamp holders 49a, 49b, 49g, 49h. Here, for convenience of showing in FIG., one cold cathode ray tube 47a and one cold cathode ray tube 47b are shown in FIG. 5. And each of the cold cathode ray tubes 47a, 47b emits light introduced into the light guiding plate 45 and function as the illumination device for illuminating the areas mainly corresponding to the window frame display areas 22L, 22C, 22R and the effect display area 5a within the area of the liquid crystal display panel 44. Further, each of the cold cathode ray tubes 47a, 47b emits light to the rear side through the openings 45L, 45C, 45R. Thus, the cold cathode ray tubes 47a, 47b construct the outer illumination device in the present invention.

In the slot machine 1, in order that light emitted from the cold cathode ray tubes 47a, 47b reaches to the front side of the liquid crystal display device 41, three cold cathode ray tubes 47a are arranged along the upper end of the light guiding plate 45 and three cold cathode ray tubes 47b are arranged along the lower end of the light guiding plate 45. Thereby, light amount of light introduced into the light guiding plate 45 is increased. Here, if light certainly reaches to the front side of the liquid crystal display device 41 by one cold cathode ray tube 47a, 47b, the number of the cold cathode ray tube 47a, 47b may be reduced than three. On the other hand, if light amount is less per one cold cathode ray tube 47a, 47b, it is desirable to increase such number than three.

Further, three cold cathode ray tubes 47a are arranged at the inner side of a lamp cover 48a which has a curved reflection plane and three cold cathode ray tubes 47b are arranged at the inner side of a lamp cover 48b which has a curved reflection plane. Based on that the lamp covers 48a, 48b are provided, light emitted from the cold cathode ray tubes 47a, 47b and going toward the outside of the light guiding plate 45 is introduced into the light guiding plate 45 without being discharged to an external.

The liquid crystal display device 101 is different from the liquid crystal display device 41 at the following points comparing therewith. That is, the first point is that the liquid crystal display device 101 does not have the non-reflection areas 44L, 44C, 44R: the second point is that touch panel 46 (mentioned later) is not arranged at the front side in the liquid crystal display device 101: and third point is that each of the reels 3L, 3C, 3R is not arranged at the rear side of the liquid crystal display device 101. However, the liquid crystal display device 101 has the same construction as that of the liquid crystal display device 41, except for the above three points.

(Inner Construction of the Slot Machine)

FIG. 7 is a block diagram showing an electrical construction (inner construction) of the slot machine 1. The slot machine 1 has a control circuit board 71 including a microcomputer 31 and a plurality of elements connected to the control circuit board 71. The control circuit board 71 has the microcomputer 31, a random number generator 35, a sampling circuit 36, a clock pulse generator 37 and a frequency divider 38. Further, the control circuit 71 has a hopper drive circuit 63, a payout completion signal circuit 65, a display drive circuit 67, a sound source IC 78, a power amplifier 79, an image control circuit 81 and an illumination drive circuit 91.

The microcomputer 31 has a CPU (Central Processing Unit) 32, a RAM (Random Access Memory) 33 and a ROM (Read Only Memory) 34. The CPU 32 operates according to programs stored in the ROM 34 and conducts signal input and output between the other elements through an I/O port 39, thereby the CPU 32 conducts whole control of the slot machine 1. The RAM 33 stores data and programs utilized when the CPU 32 operates. And for example, random numbers sampled by the sampling circuit 36 as mentioned later are temporarily stored after the game is started and both code numbers of the reels 3L, 3C, 3R and symbol numbers are stored. In the ROM 34, programs executed by the CPU 32 and permanent data are stored.

The random number generator 35 operates according to the instruction by the CPU 32 and generates random numbers within a predetermined range. And the sampling circuit 36 extracts a voluntary random number among the random numbers generated by the random number generator 35, according to the instruction by the CPU 32, and inputs the extracted random number to the CPU 32. The clock pulse generator 37 produces standard clock pulses to operate the CPU 32, and the frequency divider 38 inputs to the CPU 32 a signal obtained by dividing the standard clock pulses with a predetermined period.

Further, to the control circuit board 71, a reel drive unit 50 is connected. The reel drive unit 50 is provided with a reel position detection circuit 51 for detecting positions of the reels 3L, 3C, 3R, respectively, and a motor drive circuit 52 for inputting drive signals to motors M1, M2, M3, which are utilized to rotate the reels 3L, 3C, 3R. When the drive signals are input to the motors M1, M2, M3 from the motor drive circuit 52, the motors M1, M2, M3 operate, thereby the reels 3L, 3C, 3R are rotated. Further, to the control circuit board 71, the spin switch 8, the 1-BET switch 9, the maximum BET switch 10, the coin sensor 6a and the bill sensor 7a are connected and signals are input to the control circuit board 71 from each of them.

The hopper drive circuit 63 drives the hopper 64 according to control by the CPU 32 and the hopper 64 operates to pay out coins and pays out coins from the payout opening 13. The payout completion signal circuit 65 receives a coin number value data from a coin detection portion 66 connected thereto and outputs a coin payout completion signal to the CPU 32 when the coin number value reaches to a predetermined number value set beforehand. The coin detection portion 66 counts a coin number paid out from the hopper 64 and outputs data of the measured coin number value to the payout completion signal circuit 65. The display drive circuit 67 controls display operation of each display portion (BET number display portion 16, payout display portion 18 and credit display portion 19).

And the sound source IC 78 controls sound signals to output sounds from the speakers 12L, 12R based on the instruction from the CPU 32. The power amplifier 79 receives the sound signals from the sound source IC 78 and amplifies the sound signals input, thereby controls the speakers 12L, 12R so as to output sounds. Thereby, for example, after the game is started, sounds to raise interest for games are output at a convenient time.

Furthermore, to the CPU 32, a touch panel 56 is connected. The touch panel 56 is arranged so as to cover the surface of protect glass 42 positioned at the front side of the lower image display portion 5.

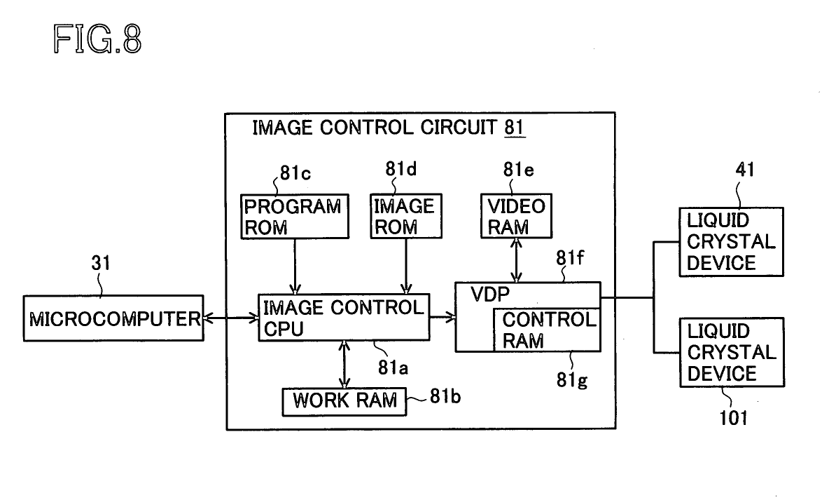

The image control circuit 81 controls image display on each of the liquid crystal display devices 44, 101. The image control circuit 81 has, as shown in FIG. 8, an image control CPU 81a, a work RAM 81b, a program ROM 81c, an image ROM 81d, a video RAM 81e and a VDP (Video Display Processor) 81f. Here, the image control CPU 81a determines images displayed on each of the liquid crystal display devices 44, 101 according to the image control program (concerning with display on the liquid crystal display devices 44, 101) stored beforehand in the program ROM 81c, based on parameters set by the microcomputer 31. The work RAM 81b is constructed as a temporary memory when the image control CPU 81a executes the image control program.

The program ROM 81c stores the image control program and various selection tables. The image ROM 81d stores dot data to form images. The video RAM 81g is constructed as a temporary memory when images are produced by the VDP 81f. The VDP 81f has the control RAM 81g and forms images corresponding to display contents of the liquid crystal display devices 44, 101 determined by the image control CPU 81a. Further, the VDP 81f outputs the images formed in the above and controls the liquid crystal display devices 44, 101 so as to display the images.

The illumination drive circuit 91 outputs drive signals according to the instruction by the CPU 32 and controls the LED lamps and the cold cathode ray tubes 48a, 48b so as to turn on and emit light.

(Operation of the Slot Machine)

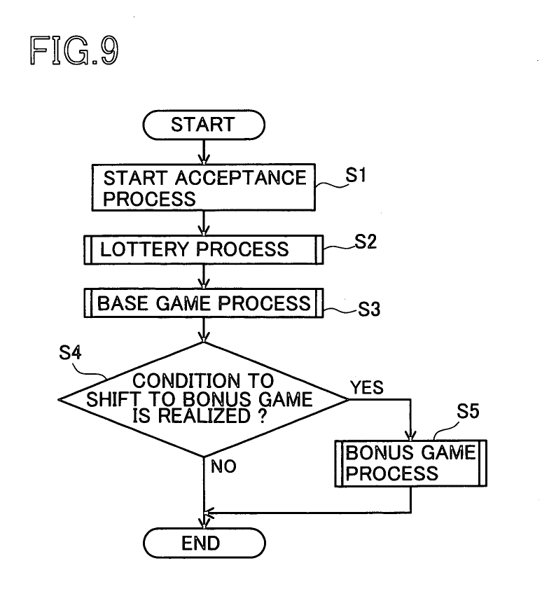

Next, operation of the slot machine 1 constructed according to the above will be described with reference to flowchart shown in FIG. 9. In the slot machine 1 of the embodiment, in addition to a base game done in a base game mode, a game in a special game mode is conducted. And when game mode is in the base game mode, the base game is conducted. On the contrary, when the game mode shifts to the special game mode, a bonus game beneficial for a player is executed.

FIG. 9 is a flowchart showing procedures in a main process executed from start of the game till termination of the game. Here, in FIG. 9, step is abbreviated as “S”.

In the slot machine 1, as shown in FIG. 9, when the main process is started, a start acceptance process is done in S1 according to control by the CPU 32 at the start of the game. Next, a lottery process is executed in S2. Further, in S3, a base game process is done while the game mode is retained to the base game mode and procedure shifts to S4. In S4, the CPU 32 determines whether or not a condition (shift condition) to shift to the bonus game is realized. Here, if the shift condition is realized, procedure shifts to S5, and on the other hand, if the shift condition is not realized, the main process is terminated. In S5, the CPU 32 shifts the game mode to the special game mode and the bonus game is executed. Thereafter, the main process is terminated.

Here, the slot machine 1 has the above construction, thereby the CPU 32 operates as the light amount adjusting device during a series of processes and the illumination instruction signal is input to the illumination drive circuit 91. Thereby, light amount control of the LED lamps 29 and the cold cathode ray tubes 47a, 47b is conducted. Thereby, the LED lamps 29 and the cold cathode ray tube 47a, 47b can be illuminated with the adjusted light amount, as a result, the images on the liquid crystal display device 41 and the symbols on the reels 3L, 3C, 3R can be displayed on the light transmittable areas 44L, 44C, 44R. Hereinafter, the image displayed on the light transmittable areas 44L, 44C, 44R is called as “display image” and the symbol displayed on the light transmittable areas 44L, 44C, 44R is called as “display symbol”.

At first, in a case that it is done priority display in which any one of the display image and the display symbol is displayed prior to the other on the light transmittable areas 44L, 44C, 44R, the CPU 32 conducts light amount adjustment of the LED lamps 29 and the cold cathode ray tubes 47a, 47b. Thereby, according to which of the display image and the display symbol is prior displayed, light amount of the LED lamps 29 and the cold cathode ray tubes 47a, 47b is changed, thus lightness and heaviness (modulation) can be given to both light amount. Thereby, any one display of the reels 3L, 3C, 3R and the liquid crystal display device 41 can be remarkably made clear than display of the other, and even if both the LED lamps 29 and the cold cathode ray tubes 47a, 47b are illuminated, the game can be done while effect according to each illumination is efficiently used, without disappearing such effect.

When light amount adjustment of the LED lamps 29 and the cold cathode ray tubes 47a, 47b is done, and for example, display of the display image is conducted prior to display of the display symbol (for example, when effect image is displayed as the display image), light amount of the cold cathode ray tubes 47a, 47b may be increased. On the other hand, when display of the display symbol is conducted prior to display of the display image (for example, when slot game is done by utilizing the display symbol), light amount of the LED lamps 29 may be increased. According to this, light amount adjustment preferable for each of the display symbol and the display image can be done.

And when display of the display image is conducted prior to display of the display symbol, in addition that light amount of the cold cathode ray tubes 47a, 47b is increased, light amount of the LED lamps 29 may be reduced (reducing the number of the LED lamp 29 which is turned on or increasing the number of the LED lamp 29 which is turned off). And when display of the display symbol is conducted prior to display of the display image, light amount of the LED lamps 29 may be increased and light amount of the cold cathode ray tubes 47a, 47b may be reduced (or the cold cathode ray tubes 47a, 47b may be turned off). Thereby, display contrast of the display symbol and the display image can be raised, thus each of the display symbol and the display image can be made clear.

And since the sheet member 200 is adhered on the outer periphery of each of the reels 3L, 3C, 3R and the sheet member 200 has a plurality of protrusions like convex lenses, the player sees and recognizes the symbols as three-dimensional images when seeing and recognizing the symbols. Here, as this kind of the sheet member 200, it can be utilized a decoration sheet on which patterns three-dimensionally appearing are changed, this decoration sheet being disclosed, for example, in Unexamined Japanese Publication No. 2003-39583.

In this case, if light amount of the cold cathode ray tubes 47a, 47b is increased, light amount provided to the liquid crystal panel 44 from the rear side thereof is increased, thereby display of the display image is made remarkably clear in comparison with a case before light amount is increased. On the other hand, if light amount of the LED lamps 29 is increased, light amount reaching to the front side of the liquid crystal display 41 while passing through the reel sheet from the inner side of the reel 3L, 3C, 3R is increased, thereby the display symbol is made remarkably clear in comparison with a case before light amount is increased. Therefore, if light amount adjustment is done while considering the above point, illumination effect of the LED lamps 29 and the cold cathode ray tubes 47a, 47b can be efficiently utilized.

By the way, in the slot machine 1, constant light amount (standard light amount) is set as light amount when the LED lamps 29 and the cold cathode ray tubes 47a, 47b are illuminated. In order to appropriately display the display symbol and the display image, in the slot machine 1, a plurality of LED lamps 29 are provided and a plurality of the cold cathode ray tubes 47a, 47b are provided and the number of the LED lamps 29 and the cold cathode ray tubes 47a, 47b, which are normally illuminated, is determined beforehand.

And in a case that light amount of the cold cathode ray tubes 47a, 47b is increased, the CPU 32 operating as the light amount adjusting device changes the number of the cold cathode ray tubes 47a, 47b which are turned on so as to increase than the number of the cold cathode ray tubes 47a, 47b which are turned on according to the standard light amount. And in a case that light amount of the LED lamps 29 is increased, the CPU 32 changes the number of the LED lamps 29 which are turned on so as to increase than the number of the LED lamps 29 which are turned on according to the standard light amount. For example, the number of the cold cathode ray tubes 47a, 47b which are turned on is set to two, and if the display image is made remarkably clear, the number of the cold cathode ray tubes 47a, 47b which are turned on is increased to six, thereby light amount adjustment is conducted.

On the other hand, when light amount adjustment is done, it is required for the CPU 32 to judge whether the display image is displayed prior to the display symbol or the display symbol is displayed prior to the display image. This judgement may be done corresponding to change of the game mode. For example, in S3˜S5 shown in FIG. 9, following processes may be done.

When the game mode is in the base game mode, that is, in S3, the LED lamps 29 are turned on and the number of the cold cathode ray tubes 47a, 47b which are turned on is set to two or four. And if the condition to shift to the bonus game is realized in S4 and the game mode shifts to the special game mode, procedure shifts to S5 and the LED lamps 29 are turned off (the number of the LED lamps 29 which are turned on is set to zero) and the number of the cold cathode ray tubes 47a, 47b may be increased to six. According to this, in the base game mode, it can be realized that the player pays attention to the display symbol rather than the display image, and on the contrary, in the special game mode, it can be realized that the player pays attention to the effect of the game rather than the display symbol.

Here, although not shown, if the game mode becomes the special game mode, the image with high contrast (density) is displayed on the liquid crystal display 41.

Here, in the above embodiments, although explanation is done according to the slot machine 1 having mechanical reels 3L, 3C, 3R, the present invention can be, of course, adopted to a Japanese pachi-slot machine having mechanical reels 3L, 3C, 3R.

Further, although the liquid crystal display device 41 is arranged in the slot machine 1, a transparent EL panel may be utilized instead of the liquid crystal display device 41. Since the transparent EL panel illuminates by itself, light amount of the light source arranged at the rear side of the liquid crystal display device 41 can be reduced by utilizing the transparent EL panel.

And in the slot machine 1, another liquid crystal display device may be arranged in front side of the liquid crystal display device 41 while retaining a transparent acrylic resin plate therebetween and superimposition construction of two liquid crystal display devices (superimposition arrangement construction) along the direction to see and recognize may be adopted. According to the superimposition arrangement construction, images enough expressing far and near feeling and cubic effect can be displayed on the lower image display portion 5.

Here, in the slot machine 1, although three reels are horizontally aligned along a straight line and arranged, the number of reels is not limited to three. For example, the number of reels may be five or nine.

And although the slot machine 1 is the gaming machine in which insertion of coins is required at the start of the game, the present invention can be adopted to a gaming machine in which credit of coins and the like or use of money information stored in a prepaid card is required at the start of the game.

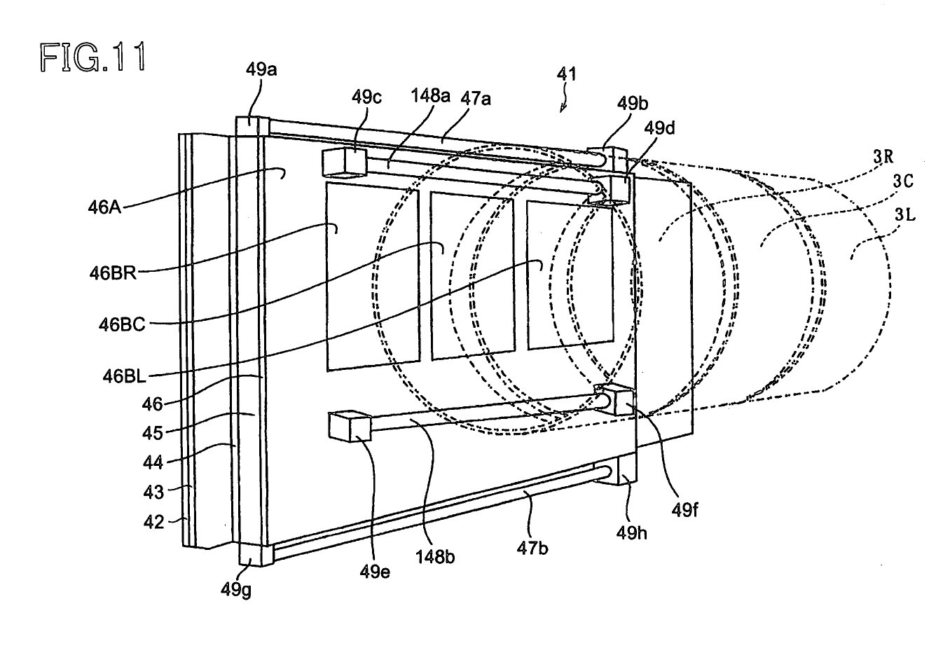

BY the way, the liquid crystal display device 41 may be constructed as shown in FIG. 11. In this liquid crystal display device 41, the cold cathode ray tubes 148a, 148b are provided and the light guiding plate 45 does not have the openings 45L, 45C, 45R (one cold cathode ray tube 47a is arranged along the upper end of the light guiding plate 45 and one cold cathode ray tube 47b is arranged along the lower end of the light guiding plate 45). The cold cathode ray tubes 148a, 148b become the outer illumination device in the present invention and each of the cold cathode ray tubes 148a, 148b is arranged at the upper position and the lower position on the rear side of the reflection film 46. And the cold cathode ray tube 148a arranged at the upper position is supported by the lamp holders 49c, 49d and the cold cathode ray tube 148b arranged at the lower position is supported by the lamp holders 49e, 49f. Further, each of the cold cathode ray tubes 148a, 148b emits light toward each of the reels 3L, 3C, 3R and illuminates the reels 3L, 3C, 3R from the outside. Light emitted from the cold cathode ray tubes 148a, 148b is reflected on each of the reels 3L, 3C, 3R and passes into the non-reflection areas 46BL, 46BC, 46BR and reaches to the liquid crystal display device 41. Thereby, the cold cathode ray tubes 148a, 148b irradiate light to the symbols on the reel sheet arranged on each of the reels 3L, 3C, 3R and emit light to the non-reflection areas 46BL, 46BC, 46BR in the reflection film 46.

1. A gaming machine comprising:
a variable display device having a rotation member on an outer periphery of which a plurality of symbols are formed and an inner illumination device for illuminating the rotation member from an inner side of the rotation member;
an image display device having an outer illumination device for illuminating the rotation member from an outer side of the rotation member and a light transmittable area through which light passes from a rear side of the light transmittable area;
a determination device for determining whether
(a) display by the variable display device is conducted on the light transmittable area prior to display by the image display device or
(b) the display by the image display device is conducted on the light transmittable area prior to the display by the variable display device; and
a light amount adjustment device for adjusting light amount emitted from the inner illumination device and the outer illumination device based on a determination result determined by the determination device.

2. The gaming machine according to claim 1, wherein the light amount adjustment device controls the outer illumination device so as to increase the light amount when the determination device determines that the display by the image display device is conducted prior to the display by the variable display device.

3. The gaming machine according to claim 2, wherein the light amount adjustment device controls the inner illumination device so as to decrease the light amount.

4. The gaming machine according to claim 1, wherein the light amount adjustment device controls the inner illumination device so as to increase the light amount when the determination device determines that the display by the variable display device is conducted prior to the display by the image display device.

5. The gaming machine according to claim 4, wherein the light amount adjustment device controls the outer illumination device so as to decrease the light amount.

6. The gaming machine according to clam 1, wherein first light amount is set to the outer illumination device and second light amount is set to the inner illumination device.

7. The gaming machine according to claim 6, wherein the light amount adjustment device controls the outer illumination device so as to increase the light amount larger than the first standard light amount when the determination device determines that the display by the variable display device is conducted prior to the display by the variable display device.

8. The gaming machine according to claim 6, wherein the light amount adjustment device controls the inner illumination device so as to increase the light amount larger than the second standard light amount when the determination device determines that the display by the variable display device is conducted prior to the display by the image display device.

9. The gaming machine according to claim 1, wherein the inner illumination device is constructed from a plurality of back lights and the outer illumination device is constructed from a plurality of cold cathode ray tubes,
wherein the light amount adjustment device adjust the light amount of the inner illumination device by changing a number of the back light which is turned on, and
wherein the light amount adjustment device adjust the light amount of the outer illumination device by changing a number of the cold cathode ray tube which is turned on.
